(19) United States
(12) Patent Application Publication
(10) Pub. No.: US 2003/0078796 A1
(43) Pub. Date: Apr. 24, 2003

(54) Server apparatus, product distribution system, product distribution management method, program to have computer perform the method, and computer readable recording medium storing the program

(76) Inventor: Masataka Togashi, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/121,664

(22) Filed: Apr. 15, 2002

(30) Foreign Application Priority Data
Oct. 24, 2001 (JP) 2001-325892

(51) Int. Cl. G06F 17/60

(52) U.S. Cl. 705/1

(57) ABSTRACT

The present invention aims to manage a product from shipment to an end user by timelily obtaining information of an owner and a management status of the shipped product in time series. A distribution system of the invention includes an inputting unit for inputting an identification number of a product to be distributed and prompting a supplier who distributes the product and at least one distribution point located in the distribution channel to input product information of the product, an identification number memory unit for storing the identification number of the product input by the inputting unit, and a product information memory unit for storing the product information input by the inputting unit correspondingly to the identification number of the product and in time series.

### BACKGROUND OF THE INVENTION

1. Field of the Invention

The present invention relates to a system for safely distributing and managing a product by sharing information on the Internet and information management system, which enables distribution management of the product and the service to be shipped and sold and registration and management of information relating to the product.

2. Description of the Related Art

FIG. 6 shows a distribution management system according to a related art.

In FIG. 6, a reference numeral 500 shows a product, 501 shows a tag, 502 shows a guarantee, 510 shows a supplier, 520 shows a distribution point such as a wholesaler, 530 shows another distribution point of a retailer, and 540 shows a user (purchaser).

The tag 501 describes product information. The guarantee describes guarantee information of the product.

Conventionally, in the process of managing products after shipment, the product and the product information are combined and distributed, so that a maker of the product (maker) which is the supplier of the product cannot perform timely and unitary information management of the product which has already been shipped.

Further, the user 540 who is the purchaser of the product does not have any effective means to confirm the maker in the contents of the tag 501 and the guarantee information of the product, which have been shipped with the product from the supplier 510, on purchasing the product. In order to confirm the maker in the contents of the tag 501 and the guarantee information of the product, the purchaser has to exchange a written confirmation, a written agreement, and/or a written guarantee with the maker by mail.

In general, the product has been distributed and sold only by trust in the distribution point 530 which is the final seller of the distribution process without confirming the maker in the contents of the tag 501 and the guarantee information of the product.

Problems to be Solved by the Invention

Conventionally, there has been a problem that in a process of the product management and the distribution management of the product, the supplier could not perform timely and unitary information management of the product after shipment.

Accordingly, while the information is gathered, the distribution status of the product may change, so that the gathered information may differ from the current distribution status of the product. Therefore, the gathered information cannot be reliable. As the information is not correct, it may be impossible to detect a false product in case that the false product has been mixed, or the information showing the false product has been mixed may be delayed, which will cause a trouble that the false product is sold without properly examined.

The present invention aims to provide a system for totally managing the shipped product from the supplier to the end user by timelily obtaining information of an owner and management status of the shipped product in time series.

### SUMMARY OF THE INVENTION

According to the present invention, a server apparatus includes:

an inputting unit for inputting an identification number of a product to be distributed, and prompting a supplier terminal which distributes the product to a distribution channel and at least one distribution point terminal for distributing and dealing the product in the distribution channel to input product information of the product;

an identification number memory unit for storing the identification number of the product input by the inputting unit; and

a product information memory unit for storing the product information input by the inputting unit corresponding to the identification number of the product in time series.

In the server apparatus of the invention, the inputting unit prompts a distribution point terminal at which the product is sold to a user to input user information of the user, and

the server apparatus further comprises a user information memory unit for storing the user information input by the inputting unit correspondingly to the identification number of the product.

In the server apparatus of the invention, the inputting unit prompts a user terminal of the user to input the user information, and

the server apparatus further comprises a user information checking unit for checking if the user information input by the user terminal matches the user information stored in the user information memory unit.

The server apparatus of the invention further includes an outputting unit for outputting the product information stored in the product information memory unit to the user terminal when the user information checking unit checks and detects a match.

In the server apparatus of the invention, the identification number of the product is at least one of a product number of the product and a lot number of the product.

In the server apparatus of the invention, the product information is at least one of a supplier of the product, time and date for receiving the product, a destination of the product, time and date for shipping the product, a price of the product, quality information of the product, withdrawal information of the product, sales cancellation information of the product, damage settlement information of the product, other kind of information of an event relating to the product which occurs during the distribution channel.

In the server apparatus of the invention, the user information is at least a name of the user and information which the user requires.

A product distribution system includes:

the server apparatus of the invention which includes

the inputting unit for prompting a distribution point at which the product is sold to a user to input user information of the user, and

a user information memory unit for storing the user information input by the inputting unit correspondingly to the identification number of the product;

a supplier terminal of the product for inputting the identification number of the product and the product information to the inputting unit; and

a distribution point terminal for inputting at least one of the product information and the user information.

According to another aspect of the invention, a product distribution management method performed by a server apparatus including:

inputting an identification number of a product to be distributed and prompting a supplier terminal which distributes the product to a distribution channel and at least one distribution point terminal for distributing and dealing the product in the distribution channel to input product information of the product;

storing the identification number of the product input; and

storing the product information input correspondingly to the identification number of the product and in time series.

A product distribution management method performed by the server apparatus of the invention, a supplier terminal, and a distribution point terminal, the product distribution management method including:

prompting the distribution point which sells the product to input user information of the product, by the server apparatus;

inputting the identification number of the product and the information of the product to the server apparatus by the supplier terminal of the product; and

inputting at least one of the product information and the user information to the server apparatus by the distribution point terminal.

According to another aspect of the invention, a program includes the following processes to have a computer execute the processes:

inputting an identification number of a product to be distributed and prompting a supplier terminal which distributes the product to a distribution channel and at least one distribution point terminal for distributing and dealing the product in the distribution channel to input product information of the product;

storing the identification number of the product input by the process of inputting the identification number; and

storing the product information input by the process of prompting to input the product information correspondingly to the identification number of the product and in time series.

A computer readable recording medium for storing the program to have a computer execute the above processes.

In the server apparatus of the invention, the inputting unit inputs product information of the product encrypted, and the server apparatus further comprising a decoding unit for decoding the product information of the product encrypted.

In the server apparatus of the invention, the product information memory unit stores the product information decoded by the decoding unit correspondingly to the identification number of the product and in time series.

### BRIEF DESCRIPTION OF THE DRAWINGS

A complete appreciation of the present invention and many of the attendant advantages thereof will be readily obtained as the same becomes better understood by reference to the following detailed description when considered in connection with the accompanying drawings, wherein:

FIG. 1 is a diagram showing a product distribution system;

FIG. 2 shows a hardware configuration of a server apparatus;

FIG. 3 shows a configuration of managing the product distribution of the server apparatus;

FIG. 4 shows a flow of the product distribution system;

FIG. 5 shows a configuration of managing the product distribution of a server apparatus according to the second embodiment; and

FIG. 6 shows a system for managing the product distribution according to related art.

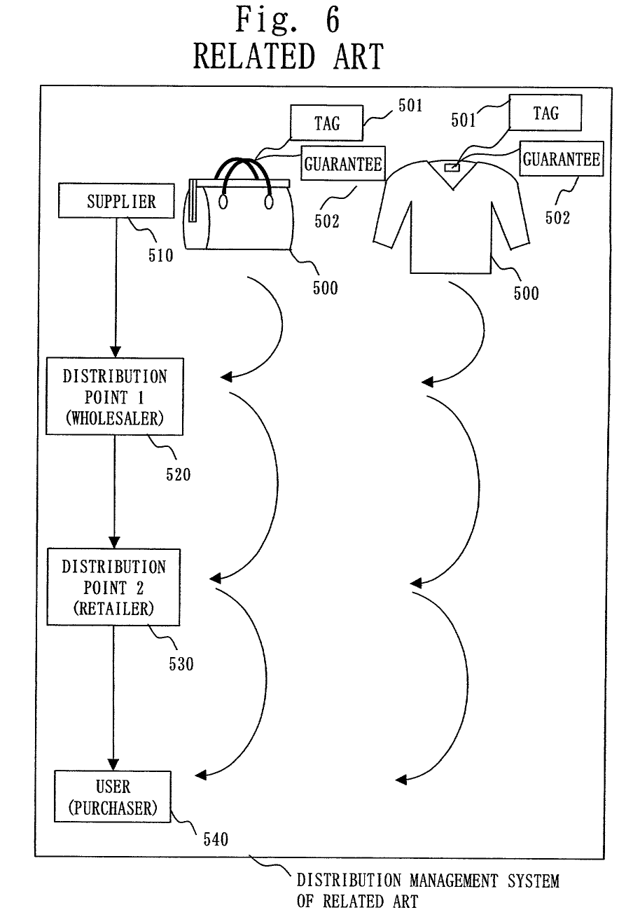

### DESCRIPTION OF THE PREFERRED EMBODIMENT

Embodiment 1

In distribution process of brand-name goods such as watches, clothes, and bags, an imitated brand-name goods may be sometimes mixed, so that it is difficult to confirm a certain product as original or not, or to guarantee the product at selling the product to an end user. Namely, the user has no means to purchase the product after confirming it as original. On the other hand, there are some brand-name goods such as automobiles; it is difficult to imitate and the original product can bear a serial product number on each. However, in case of the brand-name goods such as watches, clothes, and bags, it is easy to imitate and mass-produce them, and it is hard to bear a serial product number. Accordingly, it is necessary to create a system that can manage a whole distribution process of the product to the final sale by arranging a mechanism to prevent the false product from mixing in the distribution environment.

Accordingly, the embodiment provides a product distribution system including a server apparatus for sharing information to which another piece of information can be added when the product is passed each distribution point.

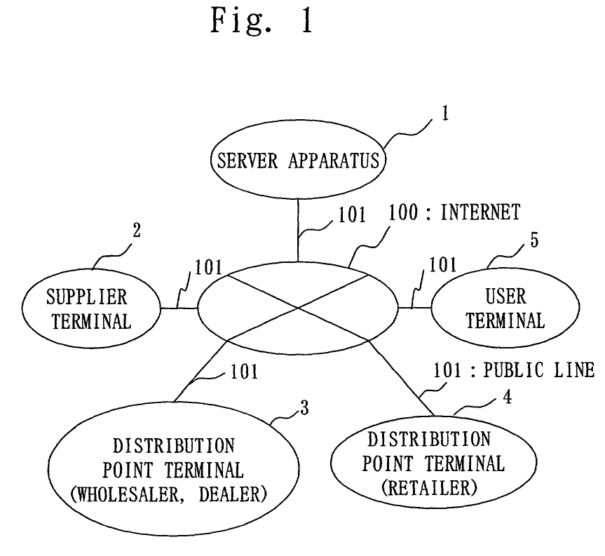

FIG. 1 shows a configuration of a product distribution system.

In FIG. 1, a reference numeral 1 shows a server apparatus, 2 shows a supplier terminal, 3 and 4 show distribution point terminals, 5 shows a user terminal, 100 shows the Internet, 101 shows a public line. The server apparatus 1 is placed, for example, at a management service provider which manages the product distribution system. Further, the server apparatus 1 can be placed at the supplier of the product. The supplier terminal 2 is placed, for example, at a maker who is the supplier of the product. Here, the distribution points are, for example, a dealer of the product distributed, a wholesaler, a retailer who sells the product to the user, and so on. The distribution point terminal 3 is placed, for example, at the dealer of the product or the wholesaler. The distribution point terminal 4 is placed, for example, at the retailer who sells the product to the user. The user terminal 5 is placed at the user who purchases the product. Or the user terminal 5 can be placed at another user who purchases or receives the product as a present from the user who purchased the product from the retailer. The distribution point terminal 3 is one in the first embodiment, however, in case of another distribution channel including plural wholesalers, plural distribution point terminals 3 can be placed at the plural wholesalers. In the first embodiment, the server apparatus 1, the supplier terminal 2, the distribution point terminals 3 and 4, and the user terminal 5 mutually communicate through the public line 101 and the Internet 100, however, the server apparatus 1, the supplier terminal 2, the distribution point terminals 3 and 4, and the user terminal 5 can communicate through an exclusive line without through the Internet 100.

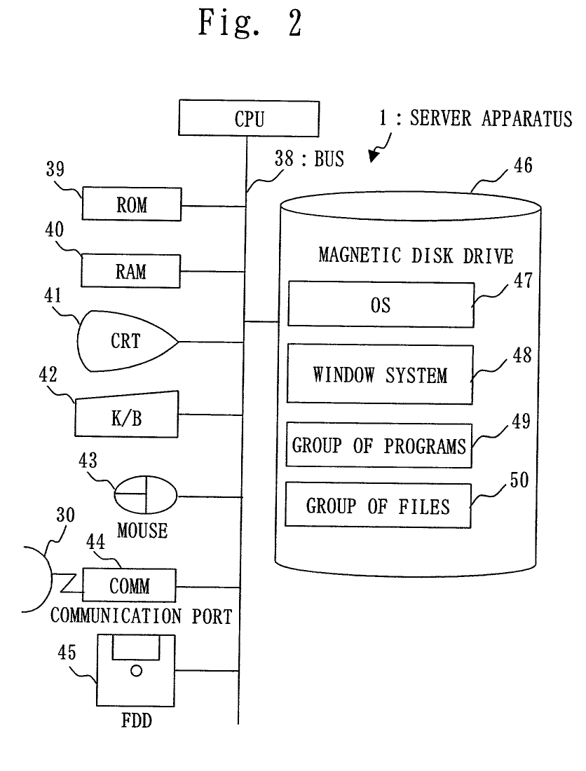

FIG. 2 shows a hardware configuration of the server apparatus.

In FIG. 2, a CPU (Central Processing Unit) 37 executing a program is connected to a ROM (Read Only Memory unit) 39, RAM (Random Access Memory unit) 40, CRT (Cathode Ray Tube) display unit 41, a keyboard (K/B) 42, a mouse 43, a communication board 44, a FDD (Flexible Disk Drive) 45, and a magnetic disk drive 46 through a bus 38.

The magnetic disk drive 46 stores an operating system (OS) 47, a window system 48, a group of programs 49, and a group of files 50. The group of programs are executed by the CPU 37, the OS 47, and the window system 48. Hardware configurations of the supplier terminal 2, the distribution terminals 3 and 4, and the user terminal 5 are the same as the configuration of FIG. 2 (though the contents of the group of programs 49 and the group of files 50 stored in the magnetic disk drive 46 may differ).

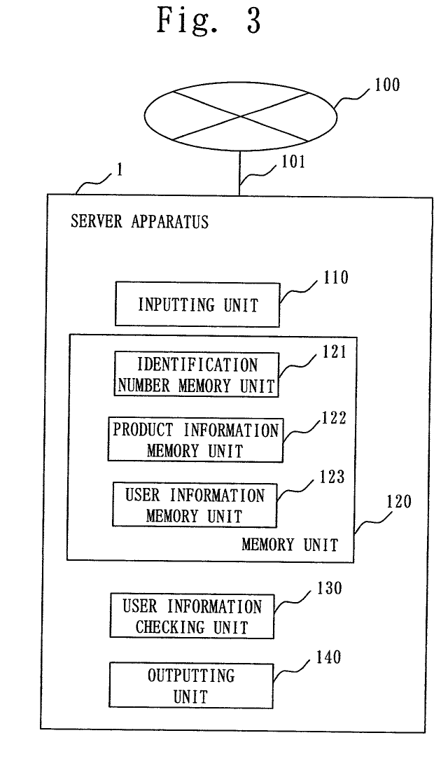

FIG. 3 shows a system of managing the product distribution within the server apparatus.

In FIG. 3, a reference numeral 110 shows an inputting unit, 120 shows a memory unit, 121 shows an identification number memory unit, 122 shows a product information memory unit, 123 shows a user information memory unit, 130 shows a user information checking unit, and 140 shows an output unit. The memory unit 120 includes the identification number memory unit 121, the product information memory unit 122, and the user information memory unit 123.

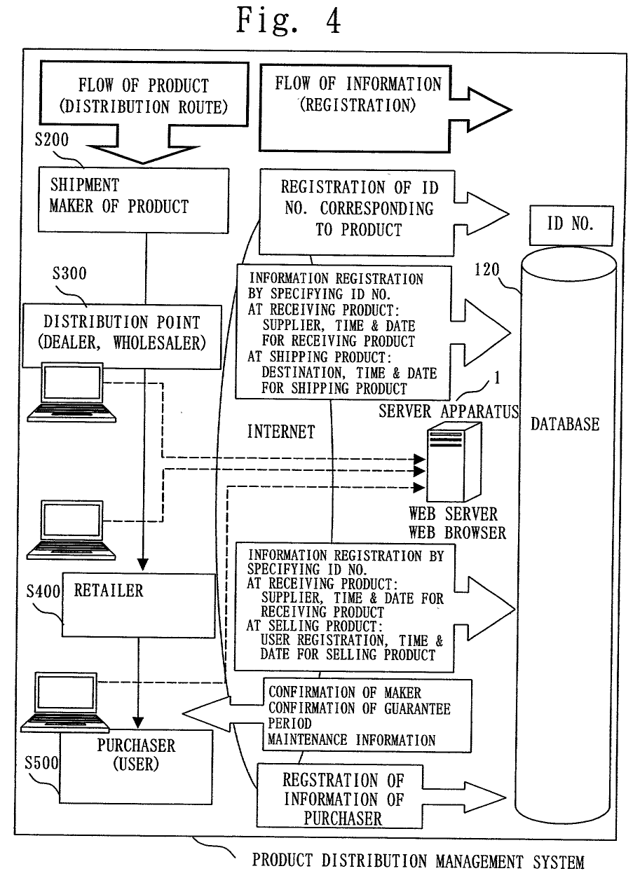

FIG. 4 shows a flow within a product distribution system.

First, at S (step) 200, the supplier terminal 2 outputs an identification number for identifying a certain product to the server apparatus 1 at shipping the product. The identification number can be any information that can identify the product. For example, a numeral, a sign, a character, or a combination of a numeral and a sign, a sign and a character, a numeral and a character, a numeral, a sign, and a character, etc. Further, the identification number can be a product number or a lot number of the product in case of mass production such as medicines. The server apparatus 1 inputs the identification number of the product from the inputting unit 110 and stores the number in the identification number memory unit 121. Or, the supplier terminal 2 can output product information such as a guarantee or after-sales service information by indicating the identification number of the product to the server apparatus 1. The supplier terminal 2 outputs the product information which is product management information necessary for each step of distribution process of the product by indicating the identification number of the product to the server apparatus 1. The product information is, for example, a destination of the product, time and date for shipping the product, a price of the shipping product, and quality information of the product, etc.

Next, at step S300, as well as the supplier terminal 2, the distribution point terminal 3 specifies the identification number of the product and outputs the product information which is management information of the product necessary for each step of distribution process of the product having the identification number. The product information output at the step S300 is, for example, a supplier of the product and time and date for receiving the product, a destination of the product and time and date for shipping the product, a cost price of the product and a shipment price of the product, quality information of the product, information of damage settlement of the product, other kind of information of an event relating to the product which occurs during the distribution channel, and so on. The above quality information of the product is, for example, a state of damage suffered in the distribution channel such as a scratch or dirt put on the product, or storage information of a product when a product such as medicines or perishables, which requires to store under a predefined condition such as at 20° C. below zero, is temporarily stored at 10° C. below zero. The server apparatus 1 inputs the product information by the inputting unit 110 and stores the product information in the product information memory unit 122. If there are plural distribution points such as the first dealer, the second dealer and so on, the distribution point terminal 3 also becomes plural. Each distribution point terminal 3 outputs the product information to the server apparatus 1 by specifying the identification number of the product. The server apparatus 1 inputs the product information by the inputting unit 110 and stores the product information in the product information memory unit 122 in a time series.

Next, at step S400, the distribution point terminal 4 specifies the identification number of the product and outputs the product information which is management information of the product necessary for each step of distribution process of the product having the identification number to the server apparatus 1 as well as the distribution point terminal 3. The product information output at the step S400 is, for example, a supplier of the product and time and date for receiving the product, the information of a user to whom the product has been sold and time and date when the product was sold, time and date when the product was repaired, and so on. The user information is, for example, the user's name and address, and so on. Or this can be information which the user requires. The information which the user requires is, for example, such as initials. Namely, the user information can be any information which the user who is a purchaser of the product can later input to the product distribution system. The server apparatus 1 inputs the product information and the user information by the inputting unit 110, stores the product information in the product information memory unit 122 in a time series, and stores the user information in the user information memory unit 123. Further, the outputting unit 140 outputs the product information stored in the product information memory unit 122 upon request from the distribution point terminal 4.

Next, at step S500, the user terminal 5 specifies the identification number of the product and outputs the user information to the server apparatus 1. The user information checking unit 130 checks if the user information input by the user terminal 5 matches the user information stored in the user information memory unit 123. The outputting unit 140 outputs the product information stored in the product information memory unit 122 to the user terminal 5 when the user information checking unit 130 checks and detects a match.

As discussed above, the first embodiment includes a unit (S200) for assigning the number for identifying one product when the product is shipped, a unit (S300) for adding the product management information required for each step of the distribution process of the product having the identification number assigned by the unit for assigning the number, a unit (S400) for exploiting the information to which the product management information is added, searching a management form and shipment status of the product when the product is sold, showing the customer the validity and the management status of the product, guaranteeing the product, and utilizing these information for sales drive, and a unit (S500) for registering a customer who purchases the product, utilizing the registered information to claim the possessive right of the product or the right to use the service of the product.

Further, according to the first embodiment, the identification number is issued when the product is shipped, the product information can be additionally written onto the product information stored in the product information memory unit 122 through the inputting unit 110 of the server apparatus 1 using the identification number of the product as original information at each distribution process. This added information can be confirmed in real time by the supplier terminal 2 which is the supplier of the product, and the identification number of the product can be changed at any time. Accordingly, if a thief steals the identification number at any step of the distribution process, the thief must follow the change of the identification number of the product. The ability to change the identification number of the product at any time can be effective to prevent the thief from stealing the identification number.

Further, according to the first embodiment, the purchaser can finally obtain the right to utilize the product at the same time of purchasing the shipped product by confirming the identification number of the product distributed with the shipped product at purchasing time of the shipped product.

The purchaser can confirm the distribution process of the product, and the identification number of the product can be changed at any time, which makes difficult to distribute a large amount of false product. Accordingly, the first embodiment of the present invention can provide a distribution system of the product in which the false product cannot be easily distributed.

As explained above, the first embodiment can unitarily manage the distribution information after shipped by supplier in real time by shipping ticket data (a number or data) which is an identification number of the product corresponding to the product, and by managing information using information utilizing tool such as WEB browser on the Internet throughout the distribution route, from the shipment of the product to the end user, so that. The embodiment has a characteristics that the information is updated, registered, and collected at each distribution point by the server apparatus 1 on the Internet, and the product management and the distribution management can be performed.

Further, according to the first embodiment, the distribution of the product can be managed at each distribution point from the shipment of the product to the end user, so that it becomes possible to obtain the information of an event relating to the product which occurs during the distribution channel and the changed status of the cost and quality of the product in each distribution channel by the supplier terminal 2, the distribution point terminals 3 and 4 in real time. Namely, the distribution information of the product can be browsed by the server apparatus 1. The information can be obtained, so that it becomes possible to indicate a specific distribution point when the product is exchanged with a false product or the product is damaged. The information can be browsed, so that it is possible that the purchaser purchases the product after confirming the product information by the server apparatus 1 through the distribution point terminal 4 at step S400. At the same time, it is possible that the purchaser purchases the product after receiving the information such as a guarantee and after-sales service information by the supplier terminal 2 through the distribution point terminal 4 at step S400.

Further, according to the first embodiment, it is possible that the supplier terminal 2 outputs the product information such as a withdrawal of the product or a cancellation of the sales of the product to the server apparatus 1, and the server apparatus 1 can store the product information such as the withdrawal of the product or the cancellation of the sales of the product. It is possible for the distribution point to obtain the information of the withdrawal or the cancellation by registering the above distribution information of the product, so that the withdrawal of the product and the damage settlement of the product can be concretely understood with the number of products at each distribution point. Accordingly, the distribution of the product can be suspended at that point, which enables a safe distribution of the product.

Further, it is possible that the supplier obtains the withdrawal of the product, the cancellation of the sales of the product which is output to the server apparatus 1 through the distribution point terminals 3 and 4, and a retailer who receives the shipped product by registering the distribution information of the product. Accordingly, the supplier can concretely understands the withdrawal of the product and the damage settlement of the product with the number of products at each distribution point, which enables a safe supply of the product.

Further, the retailer and the end user (purchaser) can be identified, so that a written guarantee, which has been necessary for performing the user management for repair under guarantee or after-sales service of the product, becomes unnecessary, and the information for the after-sales service can be managed. Here, the server apparatus 1 can receive the user information of the end user to whom the product is transferred from the purchaser from the distribution point terminal 4 or the user terminal 5 and the user information can be stored in the user information memory unit 123. It is possible to specify the end user (purchaser), the written guarantee necessary for performing the user management for repair under guarantee or after-sales service of the product becomes unnecessary, and further the after-sales service information can be managed.

On the other hand, the customer who wants to purchase the product can confirm the distribution process and the quality of the product using the ticket data accompanied with the product before the purchasing the product, and also confirm the guarantee of the product at the distributor's side and the maker's side using various information confirmation means such as the Internet, a cellular phone, a telephone, a television, newspaper, and so on.

According to the preferred embodiment of the present invention, an effect can be achieved that the product management can be performed from the shipment of the product to the sales to the final user by timelily obtaining information of an owner of the product and the management status of the product in time series.

According to the preferred embodiment of the invention, an effect can be achieved that the customer can be registered and the product can be managed to the final user of the product.

According to the preferred embodiment of the invention, an effect can be achieved that the system can be used for guaranteeing the owner's right of the customer and the right for utilizing the after-sales service.

According to the preferred embodiment of the invention, an effect can be achieved that the purchaser can purchase the product after checking the product information.

Further, another effect can be achieved that the customer can purchase the product after obtaining the information such as a guarantee and after-sales service.

According to the preferred embodiment of the invention, an effect can be achieved that the product to be distributed can be managed by an identification number assigned by the supplier instead of a temporary number for the distribution purpose.

Embodiment 2

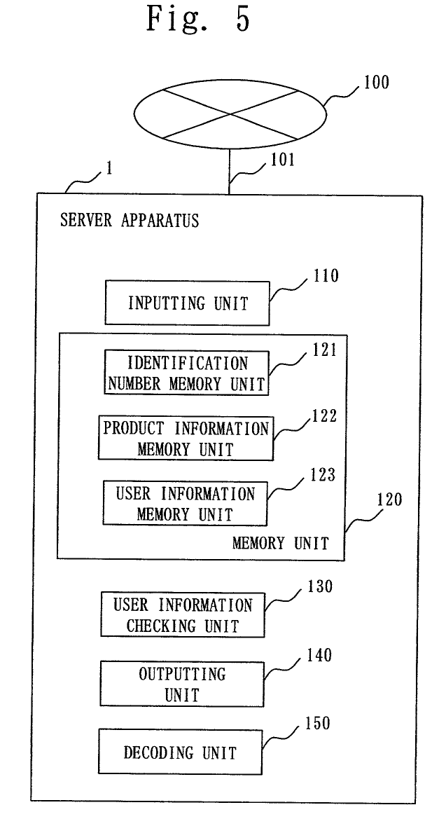

FIG. 5 shows another product distribution management using the server apparatus according to the second embodiment.

In FIG. 5, a reference numeral 150 shows a decoding unit. The configuration except the decoding unit 150 is the same as one shown in FIG. 3. The configuration and the operation of the second embodiment are the same as ones of the first embodiment except the decoding unit 150.

At steps S300 and S400, the inputting unit 110 inputs the product information of the product encrypted, and the decoding unit 150 decodes the above product information of the product encrypted.

Further, the product information memory unit 122 stores the product information decoded by the decoding unit 150 corresponding to the identification number of the product in a time series.

In the second embodiment, when the shipping channel of the product has been specified previously, a system is set to have a strong security fixed to the points of the channel which are the distribution point terminals 3 and 4, and when the shipping channel of the product has not been specified, the information is registered in a security system using an authentication through the Internet.

According to the second embodiment, when record is input in time series to the server apparatus 1 from the supplier terminal 2, the distribution point terminals 3 and 4 on the distribution channel from the shipment to the final sales of the product, a public key that is determined corresponding to each product at shipping time is used. The use of the public key and a private key of the server apparatus 1 prevents the registration of false information. Further, information which should be kept secret from the third party, information which relates to the discount of the product, or information which relates to privacy of the user can be protected. Here, since the product information memory unit 122 stores the 6 product information decoded by the decoding unit 150 in time series and corresponding to the identification number of the product, if false information is provided, the false information becomes unnatural by decoding the information using the decoding unit 150. Accordingly, the fact that the information is false becomes apparent to the supplier terminal 2, the distribution point terminals 3 and 4 on the distribution channel, and the user terminal 5.

As has been described, as for a product to be managed, an identification number is assigned to each product or each managing unit, and the information relating to the product is registered in the server apparatus 1 at each distribution point by a unit of each identification number. Since the registration of the information is confidentially performed, it is impossible for a common user to register the information. The information is registered at each distribution point in time series, so that it becomes possible to manage both of a sender and a receiver of the product in time series from producing the product. Further, the final user is registered at the retailer, a user's right and service corresponding to the identification number of the product at the time of retailing the product. Therefore, the purchaser (the final user) becomes a user who is authorized by the maker, because the purchaser has been allowed to register as a user of the product by the identification number issued by the maker. And the purchaser obtains a right to use the distributed product and is guaranteed to use a service. By applying the first and the second embodiments of the invention, the dealer who produces and sells a large amount of false products cannot make the purchaser register at retailing time. Or, even if the dealer who produces and sells a large amount of false products can make the purchaser register at retailing time, the supplier, each distribution point, and the purchaser can identify the route mixing the false product by checking the product information stored in the server apparatus 1 in time series. Accordingly, the embodiments makes it difficult to produce and sell the false product.

Further, it becomes possible to use the information of the purchaser who is a registered user as customer management information, which eliminates management process such as an issue of a written guarantee.

As discussed above, a system is provided, in which the supplier can obtain current management status of the product using the information of the product and the information of the product distribution management which is managed timelily and unitarily after the shipment of the product. And the system includes a numbering mechanism for assigning an identification number to the product at shipping time, to which data is added after the shipment, an inputting mechanism for inputting data such as timely status of the product at each point to hold the product during the distribution process, a database for managing the data safely and unitarily, a browsing mechanism for browsing and checking the product management data stored in the database with securing the confidentiality of the data.

According to the preferred embodiment of the invention, an effect can be achieved that it is possible to protect information which must be kept confidential from the third party, information relating to discount of the product, information relating to privacy of the user, and so on.

According to the preferred embodiment of the invention, an effect can be achieved that it is possible to recognize false information.

In the above explanation of the foregoing embodiments, the functions named as “so-and-so unit” can be implemented by a program executable by a computer. Namely, the magnetic disc drive 46 is a recording medium in which the program executable by the computer. The program can be generated by, for example, a C language. Or the program can be written in HTML, SGML, or XML form. Or the program can be displayed using JAVA (registered trademark).

Further, in the explanation of the foregoing embodiments, the functions named as “so-and-so unit” can be implemented by a firmware stored in the ROM 39. Or the functions can be implemented by a software, a hardware, or a combination of a software, a hardware, and a firmware.

Further, the program for implementing the embodiments can be stored in a recording medium such as the FDD 45.

Further, the CRT display unit 41 can be replaced with another display device, or an output device such as a printer. Yet further, the magnetic disc drive 46 can be replaced with a recording device using an optical disk, a CD, and other kind of recording medium.

Having thus described several particular embodiments of the present invention, various alterations, modifications, and improvements will readily occur to those skilled in the art. Such alterations, modifications, and improvements are intended to be part of this disclosure, and are intended to be within the spirit and scope of the present invention. Accordingly, the foregoing description is by way of example only, and is not intended to be limiting. The present invention is limited only as defined in the following claims and the equivalents thereto.

What is claimed is:

1. A server apparatus comprising:
an inputting unit for inputting an identification number of a product to be distributed, and prompting a supplier terminal which distributes the product to a distribution channel and at least one distribution point terminal for distributing and dealing the product in the distribution channel to input product information of the product;
an identification number memory unit for storing the identification number of the product input by the inputting unit; and
a product information memory unit for storing the product information input by the inputting unit corresponding to the identification number of the product in time series.

2. The server apparatus of claim 1,
wherein the inputting unit prompts a distribution point terminal at which the product is sold to a user to input user information of the user, and
wherein the server apparatus further comprises a user information memory unit for storing the user information input by the inputting unit correspondingly to the identification number of the product.

3. The server apparatus of claim 2,
wherein the inputting unit prompts a user terminal of the user to input the user information, and
wherein the server apparatus further comprises a user information checking unit for checking if the user information input by the user terminal matches the user information stored in the user information memory unit.

4. The server apparatus of claim 3 further comprising an outputting unit for outputting the product information stored in the product information memory unit to the user terminal when the user information checking unit checks and detects a match.

5. The server apparatus of claim 1, wherein the identification number of the product is at least one of a product number of the product and a lot number of the product.

6. The server apparatus of claim 1, wherein the product information is at least one of a supplier of the product, time and date for receiving the product, a destination of the product, time and date for shipping the product, a price of the product, quality information of the product, withdrawal information of the product, sales cancellation information of the product, damage settlement information of the product, other kind of information of an event relating to the product which occurs during the distribution channel.

7. The server apparatus of claim 2, wherein the user information is at least a name of the user and information which the user requires.

8. A product distribution system comprising:
the server apparatus of claim 1 which includes
the inputting unit for prompting a distribution point at which the product is sold to a user to input user information of the user, and
a user information memory unit for storing the user information input by the inputting unit correspondingly to the identification number of the product;
a supplier terminal of the product for inputting the identification number of the product and the product information to the inputting unit; and
a distribution point terminal for inputting at least one of the product information and the user information.

9. A product distribution management method performed by a server apparatus comprising:
inputting an identification number of a product to be distributed and prompting a supplier terminal which distributes the product to a distribution channel and at least one distribution point terminal for distributing and dealing the product in the distribution channel to input product information of the product;
storing the identification number of the product input; and
storing the product information input correspondingly to the identification number of the product and in time series.

10. A product distribution management method performed by the server apparatus of claim 9, a supplier terminal, and a distribution point terminal, the product distribution management method comprising:
prompting the distribution point which sells the product to input user information of the product, by the server apparatus;
inputting the identification number of the product and the information of the product to the server apparatus by the supplier terminal of the product; and
inputting at least one of the product information and the user information to the server apparatus by the distribution point terminal.

11. A program to have a computer execute processes of:
inputting an identification number of a product to be distributed and prompting a supplier terminal which distributes the product to a distribution channel and at least one distribution point terminal for distributing and dealing the product in the distribution channel to input product information of the product;
storing the identification number of the product input by the process of inputting the identification number; and
storing the product information input by the process of prompting to input the product information correspondingly to the identification number of the product and in time series.

12. A computer readable recording medium for storing the program to have a computer execute processes of claim 11.

13. The server apparatus of claim 1, wherein the inputting unit inputs product information of the product encrypted, and wherein the server apparatus further comprising a decoding unit for decoding the product information of the product encrypted.

14. The server apparatus of claim 13, wherein the product information memory unit stores the product information decoded by the decoding unit correspondingly to the identification number of the product and in time series.
